(19) United States
(12) Patent Application Publication
(10) Pub. No.: US 2011/0166838 A1
(43) Pub. Date: Jul. 7, 2011

(54) ALGORITHMS FOR OUTCOME PREDICTION IN PATIENTS WITH NODE-POSITIVE CHEMOTHERAPY-TREATED BREAST CANCER

(75) Inventors: Mathias Gehrmann, Leverkusen (DE); Ralf Kronenwett, Koln (DE); Udo Stropp, Haan (DE); Christian Von Törne, Solingen (DE); Karsten Weber, Leverkusen (DE)

(73) Assignee: Sividon Diagnostics, Koln (DE)

(21) Appl. No.: 12/999,522

(22) PCT Filed: Jun. 16, 2009
(86) PCT No.: PCT/EP2009/057426

§ 371 Date: Feb. 28, 2011

(30) Foreign Application Priority Data
Jun. 16, 2008 (EP) 08010916.8

(51) Int. Cl. G06F 7/60

(52) U.S. Cl. 703/2

(57) ABSTRACT

The invention relates to methods for predicting an outcome of cancer in a patient suffering from cancer, said patient having been previously diagnosed as node positive and treated with cytotoxic chemotherapy, said method comprising determining in a biological sample from said patient an expression level of a plurality of genes selected from the group consisting of ACTG1, CAl2, CALM2, CCND1, CHPT1, CLEC2B, CTSB, CXCL13, DCN, DHRS2, EIF4B, ERBB2, ESR1, FBXO28, GABRP, GAPDH, H2AFZ, IGFBP3, IGHG1, IGKC, KCTD3, KIAA0101, KRT17, MLPH, MMP1, NAT1, NEK2, NR2F2, OAZ1, PCNA, PDLIM5, PGR, PPIA, PRC1, RACGAP1, RPL37A, SOX4, TOP2A, UBE2C and VEGF; ABCB1, ABCG2, ADAM15, AKR1C1, AKR1C3, AKT1, BANF1, BCL2, BIRC5, BRMS1, CASP10, CCNE2, CENPJ, CHPT1, EGFR, CTTN, ERBB3, ERBB4, FBLN1, FIP1L1, FLT1, FLT4, FNTA, GATA3, GSTP1, Herstatin, IGF1R, IGHM, KDR, KIT, CKRT5, SLC39A6, MAPK3, MAPT, MKI67, MMP7, MTA1, FRAP1, MUC1, MYC, NCOA3, NFIB, OLFM1, TP53, PCNA, PI3K, PPERLD1, RAB31, RAD54B, RAF1, SCUBE2, STAU, TINF2, TMSL8, VGLL1, TRA@, TUBA1, TUBB, TUBB2A.

Breast Cancer (BRC) is the leading cause of death in women between ages of 35-55. Worldwide, there are over 3 million women living with breast cancer. OECD (Organization for Economic Cooperation & Development) estimates on a worldwide basis 500,000 new cases of breast cancer are diagnosed each year. One out of ten women will face the diagnosis breast cancer at some point during her lifetime.

According to today's therapy guidelines and current medical practice, the selection of a specific therapeutic intervention is mainly based on histology, grading, staging and hormonal status of the patient. Several studies have shown that adjuvant chemotherapy in patients with operable clinically high risk breast cancer is able to reduce the annual odds of recurrence and death. One of the first adjuvant treatment regimens was a combination of cyclophosphamide, methotrexate and 5-fluoruracil (CMF).

Subsequently, anthracyclines were introduced in the adjuvant breast cancer therapy resulting in an improvement of 5 years disease-free survival (DFS) of 3% in comparison with CMF. The addition of taxanes to anthracyclines resulted in a further increase of 5 years DFS of 4-7%. However, taxane-containing regimens are usually more toxic than conventional anthracycline-containing regimens resulting in a benefit only for a small percentage of patients. Currently, there are no reliable predictive markers to identify the subgroup of patients who benefit from taxanes and many aspects of a patient's specific type of tumor are currently not assessed—preventing true patient-tailored treatment.

Thus several open issues in current therapeutic strategies remain. One point is the practice of significant over-treatment of patients; it is well known from past clinical trials that 70% of breast cancer patients with early stage disease do not need any treatment beyond surgery. While about 90% of all early stage cancer patients receive chemotherapy exposing them to significant treatment side effects, approximately 30% of patients with early stage breast cancer relapse. On the other hand, one fourth of clinically high risk patients suffer from distant metastasis during five years despite conventional cytotoxic chemotherapy. Those patients are undertreated and need additional or alternative therapies. Finally, one of the most open questions in current breast cancer therapy is which patients have a benefit from addition of taxanes to conventional chemotherapy.

As such, there is a significant medical need to develop diagnostic assays that identify low risk patients for directed therapy. For patients with medium or high risk assessment, there is a need to pinpoint therapeutic regimens tailored to the specific cancer to assure optimal success.

Breast Cancer metastasis and disease-free survival prediction or the prediction of overall survival is a challenge for all pathologists and treating oncologists. A test that can predict such features has a high medical and diagnostical need. We describe here a set of genes that can predict the outcome of a patient with node-positive breast cancer following surgery and cytotoxic chemotherapy. For prediction we use an algorithm which was trained in patients with node-negative breast cancer patients without systemic therapy. Outcome refers to getting a distant metastasis or relapse within 5 to 10 years (high risk) despite getting a systemic chemotherapy or getting no metastasis or relapse within 5 to 10 years (low risk or good prognosis). Other endpoints can be predicted as well, like overall survival or death after recurrence. Surprisingly, we found that the algorithm can also identify a subgroup of patients who have a benefit from the addition of taxanes to the adjuvant chemotherapy.

Moreover, we identified further genes which could, in combination with the algorithm, define further subgroups of patients who have a benefit from the addition of taxanes.

This disclosure focuses on a breast cancer prognosis test as a comprehensive predictive breast cancer marker panel for patients with node-positive breast cancer. The prognostic test will stratify diagnosed node-positive breast cancer patients with adjuvant cytotoxic chemotherapy into low, (intermediate) or high risk groups according to a continuous score that will be generated by the algorithms. One or two cutpoints will classify the patients according to their risk (low, (intermediate) or high. The stratification will provide the treating oncologist with the likelihood that the tested patient will suffer from cancer recurrence despite chemotherapy and with the information whether the patient will have a benefit from addition of taxanes. The oncologist can utilize the results of this test to make decisions on therapeutic regimens.

The metastatic potential of primary tumors is the chief prognostic determinant of malignant disease. Therefore, predicting the risk of a patient developing metastasis is an important factor in predicting the outcome of disease and choosing an appropriate treatment.

As an example, breast cancer is the leading cause of death in women between the ages of 35-55. Worldwide, there are over 3 million women living with breast cancer. OECD (Organization for Economic Cooperation & Development) estimates on a worldwide basis 500,000 new cases of breast cancer are diagnosed each year. One out of ten women will face the diagnosis breast cancer at some point during her lifetime. Breast cancer is the abnormal growth of cells that line the breast tissue ducts and lobules and is classified by whether the cancer started in the ducts or the lobules and whether the cells have invaded (grown or spread) through the duct or lobule, and by the way the cells appear under the microscope (tissue histology). It is not unusual for a single breast tumor to have a mixture of invasive and in situ cancer. According to today's therapy guidelines and current medical practice, the selection of a specific therapeutic intervention is mainly based on histology, grading, staging and hormonal status of the patient. Many aspects of a patient's specific type of tumor are currently not assessed—preventing true patient-tailored treatment. Another dilemma of today's breast cancer therapeutic regimens is the practice of significant over-treatment of patients; it is well known from past clinical trials that 70% of breast cancer patients with early stage disease do not need any treatment beyond surgery. While about 90% of all early stage cancer patients receive chemotherapy exposing them to significant treatment side effects, approximately 30% of patients with early stage breast cancer relapse. These types of problems are common to other forms of cancer as well. As such, there is a significant medical need to develop diagnostic assays that identify low risk patients for directed therapy. For patients with medium or high risk assessment, there is a need to pinpoint therapeutic regimens tailored to the specific cancer to assure optimal success. Breast Cancer metastasis and disease-free survival prediction is a challenge for all pathologists and treating oncologists. A test that can predict such features has a high medical and diagnostic need.

About 20-30% of all breast cancers diagnosed in the US and Europe are node-positive. The number of involved axillary lymph nodes is one of the most important prognostic factor regarding survival or recurrence after potentially curative surgery. Several studies have shown that adjuvant chemotherapy in patients with operable node-positive breast cancer can eradicate occult micrometastatic disease and is able to reduce the annual odds of recurrence and death. One of the first adjuvant treatment regimens was a combination of cyclophosphamide, methotrexate and 5-fluoruracil (CMF). Subsequently, anthracyclines were introduced in the adjuvant breast cancer therapy resulting in an improvement of 5 years disease-free survival (DFS) of 3% in comparison with CMF. The taxanes (paclitaxel and docetaxel) are standard drugs in metastatic breast cancer treatment since they can increase response rate and duration of response. Several randomized studies could recently show that taxanes added to anthracyclines are also effective in the adjuvant setting and could increase 5 years DFS by 4-7%. However, taxane-containing regimens are usually more toxic (cytopenia, neuropathia) than conventional anthracycline-containing regimens resulting in a benefit only for a small percentage of patients. Currently, there are no reliable predictive markers to identify the subgroup of patients who benefit from taxanes.

Despite treatment with standard-dose adjuvant chemotherapy one fourth of node-positive patients suffer from distant metastasis during five years. After metastatic disease develops, prognosis remains poor with median survivals of 18-24 months. Thus, diagnostic tests and methods are needed which can assess certain disease-related risks, e.g. risk of development of metastasis, to identify patients who need additional or alternative therapies as well as patients who have a benefit from additional taxane treatment.

Technologies such as quantitative PCR, microarray analysis, and others allow the analysis of genome-wide expression patterns which provide new insight into gene regulation and are also a useful diagnostic tool because they allow the analysis of pathologic conditions at the level of gene expression. Quantitative reverse transcriptase PCR is currently the accepted standard for quantifying gene expression. It has the advantage of being a very sensitive method allowing the detection of even minute amounts of mRNA. Microarray analysis is fast becoming a new standard for quantifying gene expression.

Curing breast cancer patients is still a challenge for the treating oncologist as the diagnosis relies in most cases on clinical and pathological data like age, menopausal status, hormonal status, grading, and general constitution of the patient and some molecular markers like Her2/neu, p53, and others. Recent studies could show that patients with so called triple negative breast cancer have a benefit from taxanes. Unfortunately, until recently, there was no test in the market for prognosis or therapy prediction that come up with a more elaborated recommendation for the treating oncologist whether and how to treat patients. Two assay systems are currently available for prognosis, Genomic Health's OncotypeDX and Agendia's Mammaprint assay. In 2007, the company Agendia got FDA approval for their Mammaprint microarray assay that can predict with the help of 70 informative genes and a bundle of housekeeping genes the prognosis of breast cancer patients from fresh tissue (Glas A. M. et al., Converting a breast cancer microarray signature into a high-throughput diagnostic test, BMC Genomics. 2006 Oct. 30; 7:278). Genomic Health works with formalin-fixed and paraffin-embedded tumor tissues and uses 21 genes for their prognosis prediction, presented as a risk score (Esteva F T et al. “Prognostic role of a multigene reverse transcriptase-PCR assay in patients with node-negative breast cancer not receiving adjuvant systemic therapy”. Clin Cancer Res 2005; 11: 3315-3319). Additionally, Genomic Health could show that their OncotypeDX is also predictive of CMF chemotherapy benefit in node-negative, ER positive patients. Genomic Health could also show that their recurrence score in combination with further candidate genes predicts taxane benefit.

Both these assays use a high number of different markers to arrive at a result and require a high number of internal controls to ensure accurate results. What is needed is a simple and robust assay for prediction of outcome of cancer.

### OBJECTIVE OF THE INVENTION

It is an objective of the invention to provide a method for the prediction of outcome of cancer relying on a limited number of markers for node positive patients.

It is a further objective of the invention to provide a method for identification of patients who have a benefit from the addition of a taxane to standard adjuvant chemotherapy.

### DEFINITIONS

Unless defined otherwise, technical and scientific terms used herein have the same meaning as commonly understood by one of ordinary skill in the art to which this invention belongs.

The term “neoplastic disease”, “neoplastic region”, or “neoplastic tissue” refers to a tumorous tissue including carcinoma (e.g. carcinoma in situ, invasive carcinoma, metastasis carcinoma) and pre-malignant conditions, neomorphic changes independent of their histological origin, cancer, or cancerous disease.

The term “cancer” is not limited to any stage, grade, histomorphological feature, aggressivity, or malignancy of an affected tissue or cell aggregation. In particular, solid tumors, malignant lymphoma and all other types of cancerous tissue, malignancy and transformations associated therewith, lung cancer, ovarian cancer, cervix cancer, stomach cancer, pancreas cancer, prostate cancer, head and neck cancer, renal cell cancer, colon cancer or breast cancer are included. The terms “neoplastic lesion” or “neoplastic disease” or “neoplasm” or “cancer” are not limited to any tissue or cell type. They also include primary, secondary, or metastatic lesions of cancer patients, and also shall comprise lymph nodes affected by cancer cells or minimal residual disease cells either locally deposited or freely floating throughout the patient's body.

The term “predicting an outcome” of a disease, as used herein, is meant to include both a prediction of an outcome of a patient undergoing a given therapy and a prognosis of a patient who is not treated. The term “predicting an outcome” may, in particular, relate to the risk of a patient developing metastasis, local recurrence or death.

The term “prediction”, as used herein, relates to an individual assessment of the malignancy of a tumor, or to the expected survival rate (OAS, overall survival or DFS, disease free survival) of a patient, if the tumor is treated with a given therapy. In contrast thereto, the term “prognosis” relates to an individual assessment of the malignancy of a tumor, or to the expected survival rate (OAS, overall survival or DFS, disease free survival) of a patient, if the tumor remains untreated.

A “discriminant function” is a function of a set of variables used to classify an object or event. A discriminant function thus allows classification of a patient, sample or event into a category or a plurality of categories according to data or parameters available from said patient, sample or event. Such classification is a standard instrument of statistical analysis well known to the skilled person. E.g. a patient may be classified as “high risk” or “low risk”, “high probability of metastasis” or “low probability of metastasis”, “in need of treatment” or “not in need of treatment” according to data obtained from said patient, sample or event. Classification is not limited to “high vs. low”, but may be performed into a plurality categories, grading or the like. Classification shall also be understood in a wider sense as a discriminating score, where e.g. a higher score represents a higher likelihood of distant metastasis, e.g. the (overall) risk of a distant metastasis. Examples for discriminant functions which allow a classification include, but are not limited to functions defined by support vector machines (SVM), k-nearest neighbors (kNN), (naive) Bayes models, linear regression models or piecewise defined functions such as, for example, in subgroup discovery, in decision trees, in logical analysis of data (LAD) and the like. In a wider sense, continuous score values of mathematical methods or algorithms, such as correlation coefficients, projections, support vector machine scores, other similarity-based methods, combinations of these and the like are examples for illustrative purpose.

An “outcome” within the meaning of the present invention is a defined condition attained in the course of the disease. This disease outcome may e.g. be a clinical condition such as “recurrence of disease”, “development of metastasis”, “development of nodal metastasis”, development of distant metastasis”, “survival”, “death”, “tumor remission rate”, a disease stage or grade or the like.

A “risk” is understood to be a probability of a subject or a patient to develop or arrive at a certain disease outcome.

The term “risk” in the context of the present invention is not meant to carry any positive or negative connotation with regard to a patient's wellbeing but merely refers to a probability or likelihood of an occurrence or development of a given condition.

The term “clinical data” relates to the entirety of available data and information concerning the health status of a patient including, but not limited to, age, sex, weight, menopausal/hormonal status, etiopathology data, anamnesis data, data obtained by in vitro diagnostic methods such as histopathology, blood or urine tests, data obtained by imaging methods, such as x-ray, computed tomography, MRI, PET, spect, ultrasound, electrophysiological data, genetic analysis, gene expression analysis, biopsy evaluation, intraoperative findings.

The term “node positive”, “diagnosed as node positive”, “node involvement” or “lymph node involvement” means a patient having previously been diagnosed with lymph node metastasis.

It shall encompass both draining lymph node, near lymph node, and distant lymph node metastasis. This previous diagnosis itself shall not form part of the inventive method. Rather it is a precondition for selecting patients whose samples may be used for one embodiment of the present invention. This previous diagnosis may have been arrived at by any suitable method known in the art, including, but not limited to lymph node removal and pathological analysis, biopsy analysis, imaging methods (e.g. computed tomography, X-ray, magnetic resonance imaging, ultrasound), and intraoperative findings.

The term “etiopathology” relates to the course of a disease, that is its duration, its clinical symptoms, signs and parameters, and its outcome.

The term “anamnesis” relates to patient data gained by a physician or other healthcare professional by asking specific questions, either of the patient or of other people who know the person and can give suitable information (in this case, it is sometimes called heteroanamnesis), with the aim of obtaining information useful in formulating a diagnosis and providing medical care to the patient. This kind of information is called the symptoms, in contrast with clinical signs, which are ascertained by direct examination.

In the context of the present invention a “biological sample” is a sample which is derived from or has been in contact with a biological organism. Examples for biological samples are: cells, tissue, body fluids, lavage fluid, smear samples, biopsy specimens, blood, urine, saliva, sputum, plasma, serum, cell culture supernatant, and others.

A “biological molecule” within the meaning of the present invention is a molecule generated or produced by a biological organism or indirectly derived from a molecule generated by a biological organism, including, but not limited to, nucleic acids, protein, polypeptide, peptide, DNA, mRNA, cDNA, and so on.

A “probe” is a molecule or substance capable of specifically binding or interacting with a specific biological molecule.

The term “primer”, “primer pair” or “probe”, shall have ordinary meaning of these terms which is known to the person skilled in the art of molecular biology. In a preferred embodiment of the invention “primer”, “primer pair” and “probes” refer to oligonucleotide or polynucleotide molecules with a sequence identical to, complementary too, homologues of, or homologous to regions of the target molecule or target sequence which is to be detected or quantified, such that the primer, primer pair or probe can specifically bind to the target molecule, e.g. target nucleic acid, RNA, DNA, cDNA, gene, transcript, peptide, polypeptide, or protein to be detected or quantified. As understood herein, a primer may in itself function as a probe. A “probe” as understood herein may also comprise e.g. a combination of primer pair and internal labeled probe, as is common in many commercially available qPCR methods.

A “gene” is a set of segments of nucleic acid that contains the information necessary to produce a functional RNA product. A “gene product” is a biological molecule produced through transcription or expression of a gene, e.g. an mRNA or the translated protein.

An “mRNA” is the transcribed product of a gene and shall have the ordinary meaning understood by a person skilled in the art. A “molecule derived from an mRNA” is a molecule which is chemically or enzymatically obtained from an mRNA template, such as cDNA.

The term “specifically binding” within the context of the present invention means a specific interaction between a probe and a biological molecule leading to a binding complex of probe and biological molecule, such as DNA-DNA binding, RNA-DNA binding, RNA-RNA binding, DNA-protein binding, protein-protein binding, RNA-protein binding, antibody-antigen binding, and so on.

The term “expression level” refers to a determined level of gene expression. This may be a determined level of gene expression compared to a reference gene (e.g. a housekeeping gene) or to a computed average expression value (e.g. in DNA chip analysis) or to another informative gene without the use of a reference sample. The expression level of a gene may be measured directly, e.g. by obtaining a signal wherein the signal strength is correlated to the amount of mRNA transcripts of that gene or it may be obtained indirectly at a protein level, e.g. by immunohistochemistry, CISH, ELISA or RIA methods. The expression level may also be obtained by way of a competitive reaction to a reference sample.

A “reference pattern of expression levels”, within the meaning of the invention shall be understood as being any pattern of expression levels that can be used for the comparison to another pattern of expression levels. In a preferred embodiment of the invention, a reference pattern of expression levels is, e.g., an average pattern of expression levels observed in a group of healthy or diseased individuals, serving as a reference group.

The term “complementary” or “sufficiently complementary” means a degree of complementarity which is—under given assay conditions—sufficient to allow the formation of a binding complex of a primer or probe to a target molecule.

Assay conditions which have an influence of binding of probe to target include temperature, solution conditions, such as composition, pH, ion concentrations, etc. as is known to the skilled person.

The term “hybridization-based method”, as used herein, refers to methods imparting a process of combining complementary, single-stranded nucleic acids or nucleotide analogues into a single double stranded molecule. Nucleotides or nucleotide analogues will bind to their complement under normal conditions, so two perfectly complementary strands will bind to each other readily. In bioanalytics, very often labeled, single stranded probes are used in order to find complementary target sequences. If such sequences exist in the sample, the probes will hybridize to said sequences which can then be detected due to the label. Other hybridization based methods comprise microarray and/or biochip methods. Therein, probes are immobilized on a solid phase, which is then exposed to a sample. If complementary nucleic acids exist in the sample, these will hybridize to the probes and can thus be detected. Hybridization is dependent on target and probe (e.g. length of matching sequence, GC content) and hybridization conditions (temperature, solvent, pH, ion concentrations, presence of denaturing agents, etc.). A “hybridizing counterpart” of a nucleic acid is understood to mean a probe or capture sequence which under given assay conditions hybridizes to said nucleic acid and forms a binding complex with said nucleic acid. Normal conditions refers to temperature and solvent conditions and are understood to mean conditions under which a probe can hybridize to allelic variants of a nucleic acid but does not unspecifically bind to unrelated genes. These conditions are known to the skilled person and are e.g. described in “Molecular Cloning. A laboratory manual”, Cold Spring Harbour Laboratory Press, 2. Aufl., 1989. Normal conditions would be e.g. hybridization at 6× Sodium Chloride/sodium citrate buffer (SSC) at about 45° C., followed by washing or rinsing with 2×SSC at about 50° C., or e.g. conditions used in standard PCR protocols, such as annealing temperature of 40 to 60° C. in standard PCR reaction mix or buffer.

The term “array” refers to an arrangement of addressable locations on a device, e.g. a chip device. The number of locations can range from several to at least hundreds or thousands. Each location represents an independent reaction site. Arrays include, but are not limited to nucleic acid arrays, protein arrays and antibody-arrays. A “nucleic acid array” refers to an array containing nucleic acid probes, such as oligonucleotides, polynucleotides or larger portions of genes. The nucleic acid on the array is preferably single stranded. A “microarray” refers to a biochip or biological chip, i.e. an array of regions having a density of discrete regions with immobilized probes of at least about 100/cm².

A “PCR-based method” refers to methods comprising a polymerase chain reaction PCR. This is a method of exponentially amplifying nucleic acids, e.g. DNA or RNA by enzymatic replication in vitro using one, two or more primers. For RNA amplification, a reverse transcription may be used as a first step. PCR-based methods comprise kinetic or quantitative PCR (qPCR) which is particularly suited for the analysis of expression levels).

The term “determining a protein level” refers to any method suitable for quantifying the amount, amount relative to a standard or concentration of a given protein in a sample. Commonly used methods to determine the amount of a given protein are e.g. immunohistochemistry, CISH, ELISA or RIA methods. etc.

The term “reacting” a probe with a biological molecule to form a binding complex herein means bringing probe and biologically molecule into contact, for example, in liquid solution, for a time period and under conditions sufficient to form a binding complex.

The term “label” within the context of the present invention refers to any means which can yield or generate or lead to a detectable signal when a probe specifically binds a biological molecule to form a binding complex. This can be a label in the traditional sense, such as enzymatic label, fluorophore, chromophore, dye, radioactive label, luminescent label, gold label, and others. In a more general sense the term “label” herein is meant to encompass any means capable of detecting a binding complex and yielding a detectable signal, which can be detected, e.g. by sensors with optical detection, electrical detection, chemical detection, gravimetric detection (i.e. detecting a change in mass), and others. Further examples for labels specifically include labels commonly used in qPCR methods, such as the commonly used dyes FAM, VIC, TET, HEX, JOE, Texas Red, Yakima Yellow, quenchers like TAMRA, minor groove binder, dark quencher, and others, or probe indirect staining of PCR products by for example SYBR Green. Readout can be performed on hybridization platforms, like Affymetrix, Agilent, Illumina, Planar Wave Guides, Luminex, microarray devices with optical, magnetic, electrochemical, gravimetric detection systems, and others. A label can be directly attached to a probe or indirectly bound to a probe, e.g. by secondary antibody, by biotin-streptavidin interaction or the like.

The term “combined detectable signal” within the meaning of the present invention means a signal, which results, when at least two different biological molecules form a binding complex with their respective probes and one common label yields a detectable signal for either binding event.

A “decision tree” is a decision support tool that uses a graph or model of decisions and their possible consequences, including chance event outcomes, resource costs, and utility. A decision tree is used to identify the strategy most likely to reach a goal. Another use of trees is as a descriptive means for calculating conditional probabilities.

In data mining and machine learning, a decision tree is a predictive model; that is, a mapping from observations about an item to conclusions about its target value. More descriptive names for such tree models are classification tree (discrete outcome) or regression tree (continuous outcome). In these tree structures, leaves represent classifications (e.g. “high risk”/“low risk”, “suitable for treatment A”/“not suitable for treatment A” and the like), while branches represent conjunctions of features (e.g. features such as “Gene X is strongly expressed compared to a control” vs., “Gene X is weakly expressed compared to a control”) that lead to those classifications.

A “fuzzy” decision tree does not rely on yes/no decisions, but rather on numerical values (corresponding e.g. to gene expression values of predictive genes), which then correspond to the likelihood of a certain outcome.

A “motive” is a group of biologically related genes. This biological relation may e.g. be functional (e.g. genes related to the same purpose, such as proliferation, immune response, cell motility, cell death, etc.), the biological relation may also e.g. be a co-regulation of gene expression (e.g. genes regulated by the same or similar transcription factors, promoters or other regulative elements).

The term “therapy modality”, “therapy mode”, “regimen” or “chemo regimen” as well as “therapy regimen” refers to a timely sequential or simultaneous administration of anti-tumor, and/or anti vascular, and/or immune stimulating, and/or blood cell proliferative agents, and/or radiation therapy, and/or hyperthermia, and/or hypothermia for cancer therapy. The administration of these can be performed in an adjuvant and/or neoadjuvant mode. The composition of such “protocol” may vary in the dose of the single agent, timeframe of application and frequency of administration within a defined therapy window. Currently various combinations of various drugs and/or physical methods, and various schedules are under investigation.

The term “cytotoxic treatment” refers to various treatment modalities affecting cell proliferation and/or survival. The treatment may include administration of alkylating agents, antimetabolites, anthracyclines, plant alkaloids, topoisomerase inhibitors, and other antitumour agents, including monoclonal antibodies and kinase inhibitors. In particular, the cytotoxic treatment may relate to a taxane treatment. Taxanes are plant alkaloids which block cell division by preventing microtubule function. The prototype taxane is the natural product paclitaxel, originally known as Taxol and first derived from the bark of the Pacific Yew tree. Docetaxel is a semi-synthetic analogue of paclitaxel. Taxanes enhance stability of microtubules, preventing the separation of chromosomes during anaphase.

### SUMMARY OF THE INVENTION

The Invention relates to a method for predicting an outcome of breast cancer in a patient, said patient having been previously diagnosed as node positive, said method comprising:
(a) determining in a biological sample from said patient an expression level of combination of at least 9 genes said combination comprising CHPT1, CXCL13, ESR1, IGKC, MLPH, MMP1, PGR, RACGAP1, and TOP2A, or determining an expression level of a plurality of genes selected from the group consisting of MAPT, FIPL1, TP53 and TUBB;
(b) based on the expression level of said combination of genes or of plurality of genes determined in step (a) determining a risk score for each gene; and
(c) mathematically combining said risk scores to yield a combined score, wherein said combined score is indicative of a prognosis of said patient.

More generally, the invention comprises the method as defined in the following numbered paragraphs:
1. Method for predicting an outcome of cancer in a patient suffering from, said patient having been previously diagnosed as node positive, said method comprising:
   (a) determining in a biological sample from said patient an expression level of a plurality of genes selected from the group consisting of ACTG1, CAl2, CALM2, CCND1, CHPT1, CLEC2B, CTSB, CXCL13, DCN, DHRS2, EIF4B, ERBB2, ESR1, FBXO28, GABRP, GAPDH, H2AFZ, IGFBP3, IGHG1, IGKC, KCTD3, KIAA0101, KRT17, MLPH, MMP1, NAT1, NEK2, NR2F2, OAZ1, PCNA, PDLIM5, PGR, PPIA, PRC1, RACGAP1, RPL37A, SOX4, TOP2A, UBE2C and VEGF; ABCB1, ABCG2, ADAM15, AKR1C1, AKR1C3, AKT1, BANF1, BCL2, BIRC5, BRMS1, CASP10, CCNE2, CENPJ, CHPT1, EGFR, CTTN, ERBB3, ERBB4, FBLN1, FIP1L1, FLT1, FLT4, FNTA, GATA3, GSTP1, Herstatin, IGF1R, IGHM, KDR, KIT, CKRT5, SLC39A6, MAPK3, MAPT, MKI67, MMP7, MTA1, FRAP1, MUC1, MYC, NCOA3, NFIB, OLFM1, TP53, PCNA, PI3K, PPERLD1, RAB31, RAD54B, RAF1, SCUBE2, STAU, TINF2, TMSL8, VGLL1, TRA@, TUBA1, TUBB, TUBB2A.
   (b) based on the expression level of the plurality of genes determined in step (a) determining a risk score for each gene; and
   (c) mathematically combining said risk scores to yield a combined score, wherein said combined score is indicative of outcome of said patient.

The mathematical combination comprises the use of a discriminant function, in particular the use of an algorithm to determine the combined score. Such algorithms may comprise the use of averages, weighted averages, sums, differences, products and/or linear and nonlinear functions to arrive at the combined score. In particular the algorithm may comprise one of the algorithms P1c, P2e, P2e_c, P2e_Mz10, P7a, P7b, P1c, P2e_Mz10_b, and P2e_lin, CorrDiff.3, CorrDiff.9, described below.
2. Method of numbered paragraph 1, wherein said combined score is indicative of benefit from taxane therapy of said patient.
3. Method of numbered paragraph 1 or 2, wherein one, two or more thresholds are determined for said combined score and discriminated into high and low risk, high, intermediate and low risk, or more risk groups by applying the threshold on the combined score.
   4. Method of any one of the preceding numbered paragraphs additionally comprising the step of mathematically combining said combined risk score obtained in step (c) with an expression level of at least one of the genes determined in step (a) whereas the result of the combination is indicative of benefit from taxane therapy of said patient.
5. Method of any one of the preceding numbered paragraphs, wherein an expression level of a plurality of genes selected from the group consisting of CALM2, CHPT1, CXCL13, ESR1, IGKC, MLPH, MMP1, PGR, PPIA, RACGAP1, RPL37A, TOP2A and UBE2C is determined.
6. Method of any one of the preceding numbered paragraphs wherein said prediction of outcome is the determination of the risk of recurrence of cancer in said patient within 5 to 10 years or the risk of developing distant metastasis in a similar time horizon, or the prediction of death or of death after recurrence within 5 to 10 years after surgical removal of the tumor.
7. Method of any one of the preceding numbered paragraphs, wherein said prediction of outcome is a classification of said patient into one of three distinct classes, said classes corresponding to a “high risk” class, an “intermediate risk” class and a “low risk” class.
8. Method of any one of the preceding numbered paragraphs, wherein said cancer is breast cancer.
9. Method of any one of the preceding numbered paragraphs, wherein said determination of expression levels is in a formalin-fixed paraffin embedded sample or in a fresh-frozen sample.
10. Method of any one of the preceding numbered paragraphs, comprising the additional steps of:
   (d) classifying said sample into one of at least two clinical categories according to clinical data obtained from said patient and/or from said sample, wherein each category is assigned to at least one of said genes of step (a); and
   (e) determining for each clinical category a risk score;
   wherein said combined score is obtained by mathematically combining said risk scores of each patient.
11. Method of numbered paragraph 10, wherein said clinical data comprises at least one gene expression level.
12. Method of numbered paragraph 11, wherein said gene expression level is a gene expression level of at least one of the genes of step (a).
13. Method of any of numbered paragraphs 10 to 12, wherein step (d) comprises applying a decision tree.
14. Method of any one of the preceding numbered paragraphs, wherein the patient has previously received treatment by surgery and cytotoxic chemotherapy.
15. Method of numbered paragraph 12, wherein the cytotoxic chemotherapy comprises administering a taxane compound or taxane derived compound.

It is noted that the Methods of the present invention may also be applied to patients with a node negative status to predict benefit from tatxane therapy for said patient.

We used a unique panel of genes combined into an algorithm for the here presented new predictive test. The algorithm had initially been generated on follow-up data in node-negative breast cancer patients without systemic drug therapy for events like distant metastasis, local recurrence or death and data for non-events or long disease-free survival (healthy at last contact when seeing the treating physician). Then the algorithm was tested in node-positive breast cancer patients with adjuvant systemic cytotoxic chemotherapy.

The algorithm makes use of kinetic RT-PCR data from breast cancer patients.

The following set of genes was used for the algorithm: ACTG1, CAl2, CALM2, CCND1, CHPT1, CLEC2B, CTSB, CXCL13, DCN, DHRS2, EIF4B, ERBB2, ESR1, FBXO28, GABRP, GAPDH, H2AFZ, IGFBP3, IGHG1, IGKC, KCTD3, KIAA0101, KRT17, MLPH, MMP1, NAT1, NEK2, NR2F2, OAZ1, PCNA, PDLIM5, PGR, PPIA, PRC1, RACGAP1, RPL37A, SOX4, TOP2A, UBE2C and VEGF.

Of these, the following genes are especially preferred for use of the method of the present invention: CALM2, CHPT1, CXCL13, ESR1, IGKC, MLPH, MMP1, PGR, PPIA, RACGAP1, RPL37A, TOP2A and UBE2C.

Different prognosis algorithms were built using these genes by selecting appropriate subsets of genes and combining their measurement values by mathematical functions. The function value is a real-valued risk score indicating the likelihoods of clinical outcomes; it can further be discriminated into two, three or more classes indicating patients to have low, intermediate or high risk. We also calculated thresholds for discrimination.

TABLE 1
List of Genes used in the methods of the invention:
List of Genes of algorithm P2e_Mz10 and P2e_lin:

| | | | Accession |
|---|---|---|---|
| Gene | Name | Process | Number |
| ESR1 | Estrogen Receptor | Hormone | NM_000125 |
| | | Receptor | |
| PGR | Progesteron Receptor | Hormone | NM_000926 |
| | | Receptor | |
| MLPH | Melanophilin | Hormone | NM_001042467 |
| | | Receptor | |
| TOP2A | Topoisomerase II alpha | Proliferation | NM_001067 |
| RACGAP1 | Rac GTPase activating Protein 1 | Proliferation | NM_001126103 |
| CHPT1 | Choline Phosphotransferase 1 | Proliferation | NM_020244 |
| MMP1 | Matrixmetallopeptidase | Invasion | NM_002421 |
| IGKC | Immunoglobulin kappa constant | Immune System | NG_000834 |
| CXCL13 | Chemokine (C—X—C motif) Ligand 13 | Immune System | NM_006419 |
| CALM2 | Calmodulin 2 | Reference | NM_001743 |
| | | Genes | |
| PPIA | Peptidylprolyl Isomerase A | Reference | NM_021130 |
| | | Genes | |
| PAEP | Progestagen-associated Endometrial | DNA Control | NM_001018049 |
| | Protein | | |

TABLE 2
List of further Genes used in the method of the invention:
List of Genes of further algorithms:

| | | | | | | | | Accession |
|---|---|---|---|---|---|---|---|---|
| Gene | Algorithms | | | | | | | Number |
| | P1c | P2e | P2e_c | P2e_Mz10 | P7a | P7b | P7c | |
| | CorrDiff.9 | | | P2e_Mz10_b | | | | |
| | | | | P2e_lin | | | | |
| CALM2 | | | | | | | | NM_001743 |
| CHPT1 | | x | x | x | | | x | NM_020244 |
| CLEC2B | | | | | | | | NM_005127 |
| CXCL13 | x | x | x | x | x | x | x | NM_006419 |
| DHRS2 | | | | | | | | NM_005794 |
| ERBB2 | | | | | | | | NM_001005862 |
| ESR1 | x | x | x | x | | | | NM_000125 |
| FHL1 | | x | x | | | | | NM_001449 |
| GAPDH | | | | | | | | NM_002046 |
| IGHG1 | | | | | | | | NG_001019 |
| IGKC | x | x | x | x | x | x | x | NG_000834 |
| KCTD3 | | | | | | | | NM_016121 |
| MLPH | x | x | x | x | x | | | NM_001042467 |
| MMP1 | x | x | x | x | | x | x | NM_002421 |
| PGR | x | x | x | x | x | x | x | NM_000926 |
| PPIA | | | | | | | | NM_021130 |
| RACGAP1 | | x | x | x | x | x | x | NM_001126103 |
| RPL37A | | | | | | | | NM_000998 |
| SOX4 | | x | | | x | | | NM_003107 |
| TOP2A | x | x | x | x | | | | NM_001067 |
| UBE2C | x | | | | x | x | x | NM_007019 |
| VEGF | | x | x | | | | x | NM_001025366 |
| # genes of | 8 | 12 | 11 | 9 | 7 | 6 | 8 | |
| interest | | | | | | | | |

Example: Algorithm P2e_Mz10 works as follows. Replicate measurements are summarized by averaging. Quality control is done by estimating the total RNA and DNA amounts. Variations in RNA amount are compensated by subtracting measurement values of housekeeper genes to yield so called delta CT values. Delta CT values are bounded to gene-dependent ranges to reduce the effect of measurement outliers. Biologically related genes were summarized into motives: ESR1, PGR and MLPH into motive “estrogen receptor”, TOP2A and RACGAP1 into motive “proliferation” and IGKC and CXCL13 into motive “immune system”. According to the RNA-based estrogen receptor motive and the progesteron receptor status gene cases were classified into three subtypes ER−, ER+/PR− and ER+/PR+ by a decision tree, partially fuzzy. For each tree node the risk score is estimated by a linear combination of selected genes and motives: immune system, proliferation, MMP1 and PGR for the ER− leaf, immune system, proliferation, MMP1 and PGR for the ER+/PR− leaf, and immune system, proliferation, MMP1 and CHPT1 for the ER+/PR+ leaf. Risk scores of leaves are balanced by mathematical transformation to yield a combined score characterizing all patients. Patients are discriminated into high, intermediate and low risk by applying two thresholds on the combined score. The thresholds were chosen by discretizing all samples in quartiles. The low risk group comprises the samples of the first and second quartile, the intermediate and high risk groups consist of the third and fourth quartiles of samples, respectively.

Technically, the test will rely on two core technologies: 1.) Isolation of total RNA from fresh or fixed tumor tissue and 2.) Kinetic RT-PCR of the isolated nucleic acids. Both technologies are available at SMS-DS and are currently developed for the market as a part of the Phoenix program. RNA isolation will employ the same silica-coated magnetic particles already planned for the first release of Phoenix products. The assay results will be linked together by a software algorithm computing the likely risk of getting metastasis as low, (intermediate) or high.

Most algorithms rely on many genes, to be measured by chip technology (>70) or PCR-based (>15), and a complicated normalization of data (hundreds of housekeeping genes on chips) by not a less complicated algorithm that combines all data to a final score or risk prediction. Mammaprint™ (70 genes and hundreds of normalization genes; OncotypeDX™ 16 genes and 5 normalization genes). We used a FFPE (formalin-fixed, paraffin-embedded) tumor sample collection of node-negative breast cancer patients with long-term follow-up data to prepare RNA and measure the amount of RNA of several breast cancer informative genes by quantitative RT-PCR. We identified algorithms that use fewer genes (8 or 9 genes of interest and only 1 or two reference or housekeeping genes).

Performance of the above algorithms was examined in a cohort of 213 tumor samples of the randomized clinical study HeCOG 10-97. The patients were either treated with epirubicin-doxetaxel-cyclophosphamide-methotrexate-5-fluoruracil (E-T-CMF) adjuvant chemotherapy (n=102 patients) or with epirubicin-cyclophosphamide-methotrexate-5-fluoruracil (E-CMF) adjuvant chemotherapy (n=111 patients). Results were analysed for the endpoints relapse within 5 years, distant metastasis within 5 years and death within 5 years. The analysis showed that the algorithms could predict outcome in node-positive, adjuvant chemotherapy treated patients.

Best performance were achieved with algorithms P2e_Mz10 and P2e_lin. The performance of the algorithms was better in patients with more than three involved lymph nodes. Looking at patients treated with epirubicin-taxane-cyclophosphamide-methotrexate-5-fluoruracil (E-T-CMF) and E-CMF, separately, showed that the separation of the three risk groups by Kaplan-Meier analysis was better in E-CMF-treated patients than in E-T-CMF-treated patients. In particular, patients classified as intermediate or high risk and treated with E-T-CMF had a better distant metastasis-free survival than patients treated with E-CMF (Hazard ratio: 0.5)

Then we looked only on patients classified by P2e_lin as intermediate or high risk. We discretized the intermediate/high risk patients into two subgroups according to expression levels of the genes listed in table 3, respectively. We could show that the expression level of at least one of those genes was predictive of taxane benefit in the group of P2e_lin intermediate or high risk patients.

TABLE 3
List of further Genes used in the method of the invention:

ABCB1
ABCG2
ADAM15
AKR1C1
AKR1C3
AKT1
BANF1
BCL2
BIRC5
BRMS1
CASP10
CCNE2
CENPJ
CHPT1
CKRT5
CTTN
EGFR
ERBB3
ERBB4
FBLN1
Fip1L1
FLT1
FLT4
FNTA
FRAP1
GATA3
GSTP1
Herstatin
IGF1R
IgHM
KDR
KIT
MAPK3
MAPT
MKI67
MTA1
MUC1
MYC
NCOA3
NFIB
OLFM1
PCNA
PI3K
PPERLD1
RAB31
RAD54B
RAF1
SCUBE2
SLC39A6
STAU
TINF2
TMSL8
TP53
TRA@
TUBA1
TUBB
TUBB2A
VGLL1

Results are shown in the figures.

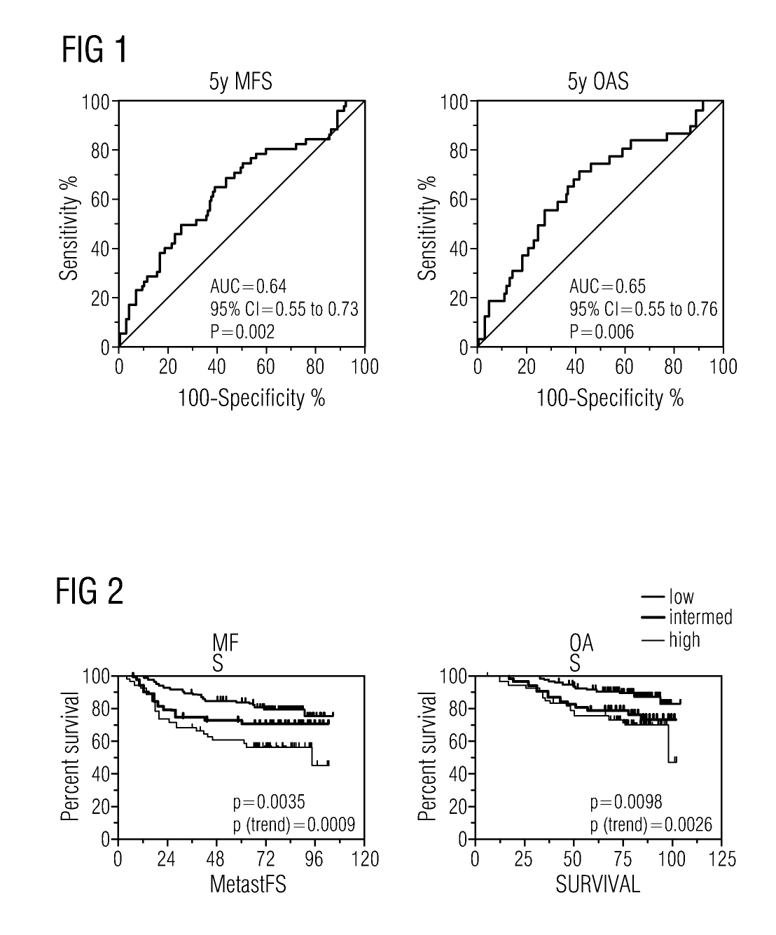

FIG. 1: ROC curves of the P2e_lin algorithm (distant metastasis within 5 years endpoint [5y MFS]) and death within 5 years endpoint [5y OAS]). Areas under the curves (AUC), 95% confidence interval (CI) and p value for significance are indicated.

FIG. 2: Kaplan-Meier survival curves for distant metastasis-free survival (MFS) and overall survival (OAS) using the P2e_lin algorithm.

Risk scores were calculated and patients were discriminated into high, intermediate and low risk by applying two thresholds on the score. The thresholds were chosen by discretizing all samples in quartiles. The low risk group comprises the samples of the first and second quartile, the intermediate and high risk groups consist of the third and fourth quartiles of samples, respectively. Log rank test and log rank test for trend were performed and p values were calculated.

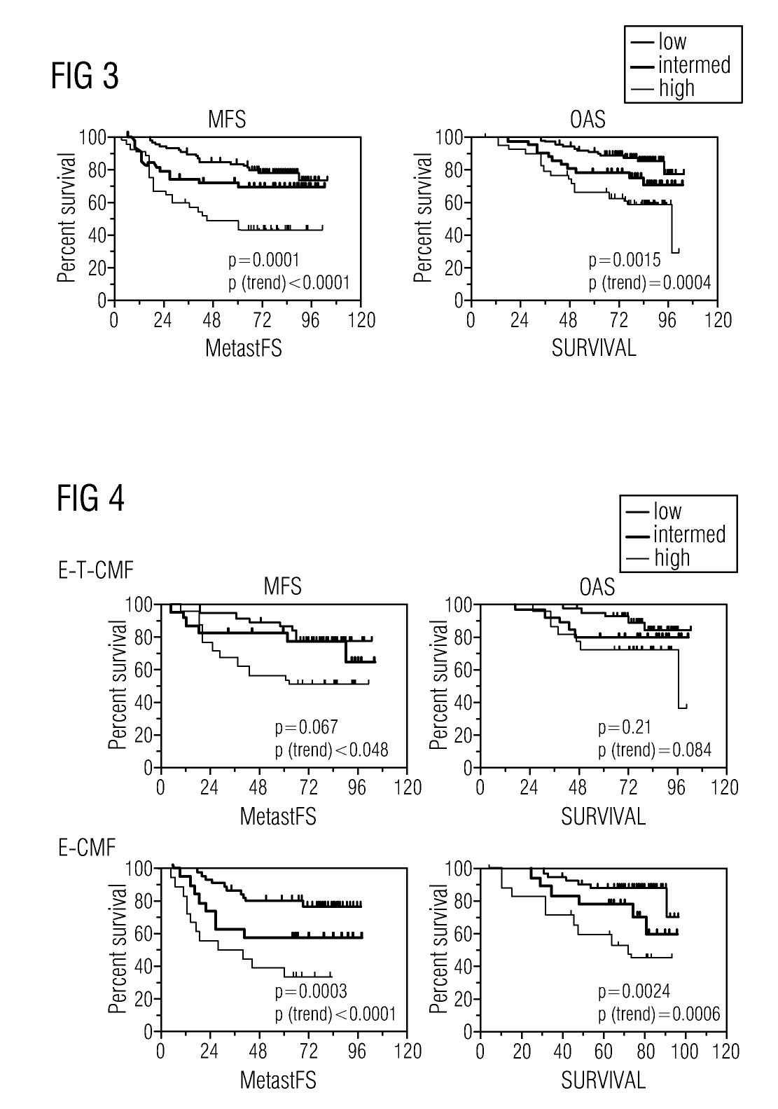

FIG. 3: Better performance of P2e_lin algorithm in patients with more than 3 involved lymph nodes

Kaplan-Meier analysis on the basis of the three risk groups was performed for MFS and OAS in patients with more than 3 involved lymph nodes. Log rank test and log rank test for trend were performed and p values were calculated.

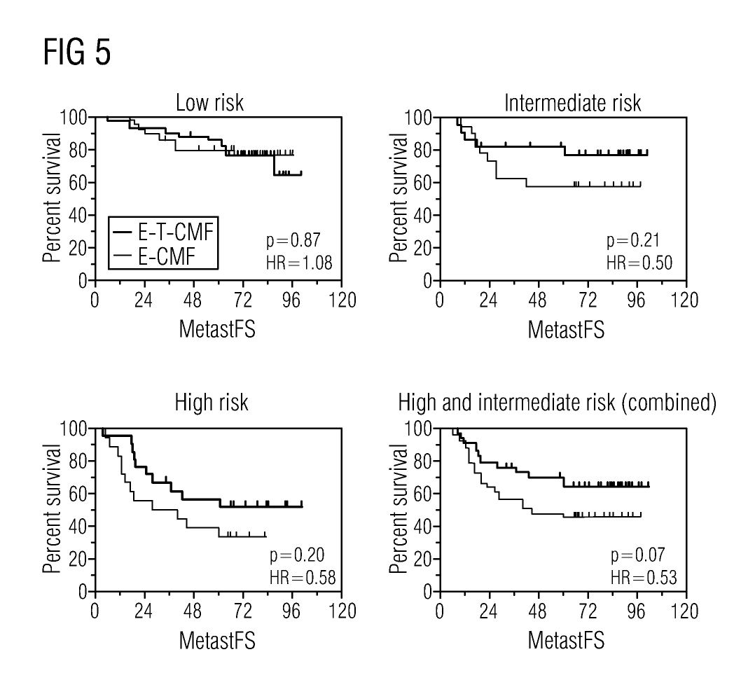

FIG. 4: Separation of three risk groups is better in patients treated with E-CMF than in patients treated with E-T-CMF.

Kaplan-Meier analyses were performed for patients with more than 3 lymph nodes for the two treatment arms (E-T-CMF vs. E-CMF), separately. Log rank test and log rank test for trend were performed and p values were calculated.

FIG. 5: Risk score is predictive of benefit from addition of taxane to adjuvant chemotherapy.

Kaplan-Meier analyses comparing E-T-CMF with E-CMF therapy were performed for low, intermediate, high and combined intermediate/high risk groups. P values and hazard ratios were calculated using log rank test.

Further it could be shown that low expression of MAPT is predictive of taxane benefit in patients with intermediate or high risk score.

Patients with intermediate or high risk score (P2e_lin) were discretized into two groups according to MAPT RNA expression level (cutpoint (20−deltaCt(RPL37A): 10.4). Kaplan-Meier analyses comparing E-T-CMF with E-CMF therapy were performed for low and high MAPT expression. P values and hazard ratios were calculated using log rank test.

In contrast to published data for all breast cancer patients low MAPT expression was predictive of taxane benefit in the subgroup of intermediate or high risk score patients. Looking at all patients in our study, MAPT expression was only prognostic but not predictive of taxane benefit.

Further it could be shown that high expression of Fip1L1 is predictive of taxane benefit in patients with intermediate or high risk score.

Patients with intermediate or high risk score (P2e_lin) were discretized into two groups according to Fip1L1 RNA expression level (cutpoint (20−deltaCt(RPL37A): 13.6). Kaplan-Meier analyses comparing E-T-CMF with E-CMF therapy were performed for low and high Fip1L1 expression. P values and hazard ratios were calculated using log rank test.

High Fip1L1 expression was predictive of taxane benefit in the subgroup of intermediate or high risk score patients. Looking at all patients, Fip1L1 was neither prognostic nor predictive of taxane benefit.

Further it could be shown that high expression of TP53 is predictive of taxane benefit in patients with intermediate or high risk score.

Patients with intermediate or high risk score (P2e_lin) were discretized into two groups according to TP53 RNA expression level (cutpoint (20−deltaCt(RPL37A): 13.52). Kaplan-Meier analyses comparing E-T-CMF with E-CMF therapy were performed for low and high TP53 expression. P values and hazard ratios were calculated using log rank test.

High TP53 expression was predictive of taxane benefit in the subgroup of intermediate or high risk score patients. Looking at all patients, TP53 was only prognostic but not predictive of taxane benefit.

Further it could be shown that high expression of TUBB is predictive of taxane benefit in patients with intermediate or high risk score.

Patients with intermediate or high risk score (P2e_lin) were discretized into two groups according to TUBB RNA expression level (cutpoint (20−deltaCt(RPL37A): 11.0). Kaplan-Meier analyses comparing E-T-CMF with E-CMF therapy were performed for low and high TUBB expression. P values and hazard ratios were calculated using log rank test.

High TUBB expression was predictive of taxane benefit in the subgroup of intermediate or high risk score patients. Looking at all patients, TUBB was only prognostic but not predictive of taxane benefit.

### EXAMPLES

Gene expression can be determined by a variety of methods, such as quantitative PCR, Microarray-based technologies and others.

### Molecular Methods

RNA was isolated from formalin-fixed paraffin-embedded (“FFPE”) tumor tissue samples employing an experimental method based on proprietary magnetic beads from Siemens Medical Solutions Diagnostics. In short, the FFPE slide were lysed and treated with Proteinase K for 2 hours 55° C. with shaking. After adding a binding buffer and the magnetic particles (Siemens Medical Solutions Diagnostic GmbH, Cologne, Germany) nucleic acids were bound to the particles within 15 minutes at room temperature. On a magnetic stand the supernatant was taken away and beads were washed several times with washing buffer. After adding elution buffer and incubating for 10 min at 70° C. the supernatant was taken away on a magnetic stand without touching the beads. After normal DNAse I treatment for 30 min at 37° C. and inactivation of DNAse I the solution was used for reverse transcription-polymerase chain reaction (RT-PCR).

RT-PCR was run as standard kinetic one-step Reverse Transcriptase TaqMan™ polymerase chain reaction (RT-PCR) analysis on a ABI7900 (Applied Biosystems) PCR system for assessment of mRNA expression. Raw data of the RT-PCR can be normalized to one or combinations of the housekeeping genes RPL37A, GAPDH, CALM2, PPIA, ACTG1, OAZ1 by using the comparative ΔΔCT method, known to those skilled in the art. In brief, a total of 40 cycles of RNA amplification were applied and the cycle threshold (CT) of the target genes was set as being 0.5. CT scores were normalized by subtracting the CT score of the housekeeping gene or the mean of the combinations from the CT score of the target gene (Delta CT).

RNA results were then reported as 20−Delta CT or 2^{((20-(CT Target Gene-CT Housekeeping Gene)*(-1)))} (2̂(20−(CT Target Gene−T Housekeeping Gene)*(−1))) scores, which would correlate proportionally to the mRNA expression level of the target gene. For each gene specific Primer/Probe were designed by Primer Express® software v2.0 (Applied Biosystems) according to manufacturers instructions.

### Statistics

The statistical analysis was performed with Graph Pad Prism Version 4 (Graph Pad Prism Software, Inc).

The clinical and biological variables were categorised into normal and pathological values according to standard norms. The Chi-square test was used to compare different groups for categorical variables. To examine correlations between different molecular factors, the Spearman rank correlation coefficient test was used.

For univariate analysis, logistic regression models with one covariate were used when looking at categorical outcomes. Survival curves were estimated by the method of Kaplan and Meier, and the curves were compared according to one factor by the log rank test.

In a representative example, quantitative reverse transcriptase PCR was performed according to the following protocol:

### Primer/Probe Mix:

| | | |
|---|---|---|
| 50 | μl | 100 μM Stock Solution Forward Primer |
| 50 | μl | 100 μM Stock Solution Reverse Primer |
| 25 | μl | 100 μM Stock Solution Taq Man Probe |
| bring to 1000 | μl | with water |
| 10 | μl | Primer/Probe Mix (1:10) are lyophilized, 2.5 h RT |

### RT-PCR Assay Set-Up for 1 Well:

| | |
|---|---|
| 3.1 μl | Water |
| 5.2 μl | RT qPCR MasterMix (Invitrogen) with ROX dye |
| 0.5 μl | MgSO4 (to 5.5 mM final concentration) |
| 1 μl | Primer/Probe Mix dried |
| 0.2 μl | RT/Taq Mx (-RT: 0.08 μL Taq) |
| 1 μl | RNA (1:2) |

### Thermal Profile:

RT step

| | | |
|---|---|---|
| 50° C. | 30 | Min* |
| 8° C. | ca. 20 | Min* |
| 95° C. | 2 | Min |

PCR cycles (repeated for 40 cycles)

| | | |
|---|---|---|
| 95° C. | 15 | Sec. |
| 60° C. | 30 | Sec. |

Gene expression can be determined by known quantitative PCR methods and devices, such as TagMan, Lightcycler and the like. It can then be expressed e.g. as cycle threshold value (CT value).

Description of a MATLAB™ file to calculate from raw Ct value the risk prediction of a patient:

The following is a Matlab script containing examples of some of the algorithms used in the invention (Matlab R2007b, Version 7.5.0.342, © by The MathWorks Inc.). User-defined comments are contained in lines preceded by the “%” symbol. These comments are overread by the program and are for the purpose of informing the user/reader of the script only. Command lines are not preceded by the “%” symbol:

```
function risk = predict(e, type)¶
% input “e”: gene expression values of patients. Variable “e” is of type¶
%  struct, each field is a numeric vector of expression values of the¶
%  patients. The field name corresponds to the gene name. Expression¶
%  values are pre-processed delta-CT values.¶
% input “type”: name of the algorithm (string)¶
% output risk: vector of risk scores for the patients. The higher the
score¶
%  the higher the estimated probability for a metastasis or desease-¶
%  related death to occur within 5 or 10 years after surgery. Negative¶
%  risk scores are called “low risk”, positive risk score are called
“high¶
%  risk”.¶
switch type¶
    case ‘P1c’¶
        % adjust values for platform¶
        CXCL13 = (e.CXCL13 −11.752821)  /  1.019727 + 8.779238;¶
        ESR1 = (e.ESR1 −15.626214)  /  1.178223 + 10.500000;¶
        IGKC = (e.IGKC −11.752725)  /  1.731738 + 11.569842;¶
        MLPH = (e.MLPH −14.185453)  /  2.039551 + 11.000000;¶
        MMP1 = (e.MMP1 − 9.484186)  /  0.987988 + 6.853865;¶
        PGR = (e.PGR −13.350160)  / 0.953809 + 6.000000;¶
        TOP2A = (e.TOP2A −13.027047)  /  1.300098 + 9.174689;¶
        UBE2C = (e.UBE2C −14.056418)  /  1.160254 + 9.853476;¶
  ¶
        % prediction of subtype¶
        srNoise = 0.5;¶
        info.srStatusConti = 2 * logit((ESR1−10.5)/srNoise) +
logit((PGR− 6)/srNoise) + logit((MLPH−11)/srNoise);¶
        info.srStatus = (info.srStatusConti >= 2) + 0;¶
        prNoise = 1;¶
        info.prStatus = logit((PGR−6)/prNoise);¶
        info.wgt0 = 1 − info.srStatus;¶
        info.wgt1 = info.srStatus .* (1−info.prStatus);¶
        info.wgt2 = info.srStatus .* info.prStatus;¶
  ¶
        % risks of subtypes¶
        info.risk0 = (logit((CXCL13−10.194199)*−0.307769) + ...¶
```

logit((IGKC−12.314798)*−0.382648) + ...¶
logit((MLPH−10.842093)*−0.218234) + ...¶
logit((MMP1−8.201517)*0.157167) + ... ¶
logit((ESR1−9.031409)*−0.285311) −2.623903) *

2.806133;¶
info.risk1 = (logit((TOP2A−8.820398)*0.697681) + ...¶

logit((UBE2C−9.784955)*1.123699) + ...¶
logit((PGR−5.387180)*−0.328050) −1.616721) *

2.474979;¶
info.risk2 = (logit((CXCL13−4.989277)*−0.142064) + ...¶

logit((IGKC−8.854017)*−0.232467) + ...¶
logit((MMP1−9.971173)*0.127538) −1.321320) *

```
3.267279;¶
  ¶
        % final risk¶
        risk = info.risk0 .* info.wgt0 + info.risk1 .* info.wgt1 +
info.risk2 .* info.wgt2 + 0.8;¶
  ¶
    case ‘P2e’¶
        % adjust values for platform¶
        ESR1  = (e.ESR1 −15.652953)  /  1.163477 + 10.500000;¶
        MLPH = (e.MLPH −14.185453)  /  2.037305 + 11.000000;¶
        PGR = (e.PGR −13.350160)  /  0.957324 + 6.000000;¶
  ¶
        % prediction of subtype¶
        srNoise = 0.5;¶
        info.srStatusConti = 2 * logit((ESR1−10.5)/srNoise) +
logit((PGR− 6)/srNoise) + logit((MLPH−11)/srNoise);¶
        info.srStatus = (info.srStatusConti >= 2) + 0;¶
        prNoise = 1;¶
        info.prStatus = logit((PGR−6)/prNoise);¶
        info.wgt0 = 1 − info.srStatus;¶
        info.wgt1 = info.srStatus .* (1−info.prStatus);¶
        info.wgt2 = info.srStatus .* info.prStatus;¶
  ¶
        % motives¶
        immune = e.IGKC + e.CXCL13;¶
        prolif = 1.5 * e.RACGAP1 + e.TOP2A;¶
        ¶
        % risks of subtypes¶
        info.risk0 = ...¶
```

+−0.0649147*immune ...¶
+ 0.2972054*e.FHL1 ...¶
+ 0.0619860*prolif ...¶
+ 0.0283435*e.MMP1 ...¶
+ 0.0596162*e.VEGF ...¶
+−0.0403737*e.MLPH ...¶
+−4.1421322;¶

info.risk1 = ...¶

+−0.0329128*e.FHL1 ...¶
+ 0.1052475*prolif ...¶
+ 0.0293242*e.MMP1 ...¶
+−0.1035659*e.PGR ...¶
+ 0.0738236*e.SOX4 ...¶
+−3.1319335;¶

info.risk2 = ...¶

+−0.0363946*immune ...¶
+ 0.0717352*prolif ...¶
+−0.1373369*e.CHPT1 ...¶
+ 0.0840428*e.SOX4 ...¶
+ 0.0157587*e.MMP1 ...¶
+−0.9378916;¶

```
  ¶
        % final risk¶
        risk = info.risk0 .* info.wgt0 + info.risk1 .* info.wgt1 +
info.risk2 .* info.wgt2 + 0.6;¶
    ¶
    case ‘P2e_c’¶
        % adjust values for platform¶
        ESR1  = (e.ESR1 −15.652953)  /  1.163477 + 10.500000;¶
        MLPH = (e.MLPH −14.185453)  /  2.037305 + 11.000000;¶
        PGR = (e.PGR −13.350160)  /  0.957324 + 6.000000;¶
  ¶
        % prediction of subtype¶
        srNoise = 0.5;¶
        info.srStatusConti = 2 * logit((ESR1−10.5)/srNoise) +
logit((PGR− 6)/srNoise) + logit((MLPH−11)/srNoise);¶
        info.srStatus = (info.srStatusConti >= 2) + 0;¶
        prNoise = 1;¶
        info.prStatus = logit((PGR−6)/prNoise);¶
        info.wgt0 = 1 − info.srStatus;¶
        info.wgt1 = info.srStatus .* (1−info.prStatus);¶
        info.wgt2 = info.srStatus .* info.prStatus;¶
  ¶
        % motives¶
        immune = 0.5 * e.IGKC + 0.5 * e.CXCL13;¶
        prolif = 0.6 * e.RACGAP1 + 0.4 * e.TOP2A;¶
        ¶
        % risks of subtypes¶
        info.risk0 = ...¶
```

+−0.1283655*immune ...¶
+ 0.3106840*e.FHL1 ...¶
+ 0.0319581*e.MMP1 ...¶
+ 0.2304728*prolif ...¶
+ 0.0711659*e.VEGF ...¶
+ 0.0123868*e.ESR1 ...¶
+−6.1644527 + 1;¶

info.risk1 = ...¶

+ 0.3018777*prolif ...¶
+−0.0992731*e.PGR ...¶
+ 0.0351513*e.MMP1 ...¶
+−0.0302850*e.FHL1 ...¶
+−2.5403380;¶

info.risk2 = ...¶

+ 0.1989859*prolif ...¶
+−0.1252159*e.CHPT1 ...¶
+−0.0808729*immune ...¶
+ 0.0227976*e.MMP1 ...¶
+ 0.0433237;¶

```
  ¶
        % final risk¶
        risk = info.risk0 .* info.wgt0 + info.risk1 .* info.wgt1 +
info.risk2 .* info.wgt2 + 0.3;¶
  ¶
    case ‘P2e_Mz10’¶
        % adjust values for platform¶
        ESR1  = (e.ESR1 −15.652953)  /  1.163477 + 10.500000;¶
        MLPH = (e.MLPH −14.185453)  /  2.037305 + 11.000000;¶
        PGR = (e.PGR −13.350160)  /  0.957324 + 6.000000;¶
  ¶
        % prediction of subtype¶
        srNoise = 0.5;¶
        info.srStatusConti = 2 * logit((ESR1−11)/srNoise) +
logit((PGR− 6)/srNoise) + logit((MLPH−11)/srNoise);¶
        info.srStatus = (info.srStatusConti >= 2) + 0;¶
        prNoise = 1;¶
        info.prStatus = logit((PGR−6)/prNoise);¶
        info.wgt0 = 1 − info.srStatus;¶
        info.wgt1 = info.srStatus .* (1−info.prStatus);¶
        info.wgt2 = info.srStatus .* info.prStatus;¶
        ¶
        % motives¶
        immune = 0.5 * e.IGKC + 0.5 * e.CXCL13;¶
        prolif = 0.6 * e.RACGAP1 + 0.4 * e.TOP2A;¶
  ¶
        % risks of subtypes¶
        info.risk0 = +−0.1695553*immune + 0.2442442*prolif +
0.0576508*e.MMP1 +−0.0329610*e.PGR +−1.2666276;¶
        info.risk1 = +−0.1014611*immune + 0.1520673*prolif +
0.0127294*e.MMP1 +−0.0724982*e.PGR + 0.0307697;¶
        info.risk2 = +−0.1209503*immune + 0.0491344*prolif +
0.0749897*e.MMP1 +−0.0602048*e.CHPT1 + 0.8781799;¶
        ¶
        % final risk¶
        risk = info.risk0 .* info.wgt0 + info.risk1 .* info.wgt1 +
info.risk2 .* info.wgt2 + 0.25;¶
  ¶
    case ‘P2e_Mz10_b’¶
        % adjust values for platform¶
        ESR1 = (e.ESR1 −15.652953)  /  1.163477 + 10.500000;¶
        MLPH = (e.MLPH −14.185453)  /  2.037305 + 11.000000;¶
        PGR = (e.PGR −13.350160)  /  0.957324 + 6.000000;¶
  ¶
        % prediction of subtype¶
        srNoise = 0.5;¶
        info.srStatusConti = 2 * logit((ESR1−11)/srNoise) +
logit((PGR− 6)/srNoise) + logit((MLPH−11)/srNoise);¶
        info.srStatus = (info.srStatusConti >= 2) + 0;¶
        prNoise = 1;¶
        info.prStatus = logit((PGR−6)/prNoise);¶
        info.wgt0 = 1 − info.srStatus;¶
        info.wgt1 = info.srStatus .* (1−info.prStatus);¶
        info.wgt2 = info.srStatus .* info.prStatus;¶
        ¶
        % motives¶
        immune = 0.5 * e.IGKC + 0.5 * e.CXCL13;¶
        prolif = 0.6 * e.RACGAP1 + 0.4 * e.TOP2A;¶
  ¶
        % risks of subtypes¶
        info.risk0 = +−0.1310102*immune + 0.1845093*prolif +
0.1511828*e.CHPT1 +−0.1024023*e.PGR +−2.0607350;¶
        info.risk1 = +−0.0951339*immune + 0.1271194*prolif +−
0.1865775*e.CHPT1 +−0.0365784*e.PGR + 2.9353027;¶
        info.risk2 = +−0.1209503*immune + 0.0491344*prolif +−
0.0602048*e.CHPT1 + 0.0749897*e.MMP1 + 0.8781799;¶
        ¶
        % final risk¶
        risk = info.risk0 .* info.wgt0 + info.risk1 .* info.wgt1 +
info.risk2 .* info.wgt2 + 0.3;¶
  ¶
    case ‘P2e_lin’ ¶
        % motives¶
        estrogen = 0.5 * e.ESR1 + 0.3 * e.PGR + 0.2 * e.MLPH;¶
        immune = 0.5 * e.IGKC + 0.5 * e.CXCL13;¶
        prolif = 0.6 * e.RACGAP1 + 0.4 * e.TOP2A;¶
  ¶
        % final risk¶
```

| | |
|---|---|
| risk = | +−0.0733386*estrogen ...¶ |
| | +−0.1346660*immune ...¶ |
| | + 0.1468378*prolif ...¶ |
| | + 0.0397999*e.MMP1 ...¶ |
| | +−0.0151972*e.CHPT1 ...¶ |
| | + 0.6615265 ...¶ |
| | + 0.25;¶ |

```
  ¶
    case ‘P7a’ ¶
        % motives¶
        prolif = 0.6 * e.RACGAP1 + 0.4 * e.UBE2C;¶
        immune = 0.5 * e.IGKC + 0.5 * e.CXCL13;¶
        estrogen = 0.5 * e.MLPH + 0.5 * e.PGR;¶
  ¶
        % final risk¶
```

| | |
|---|---|
| risk = | +0.2944 * prolif ... ¶ |
| | −0.2511 * immune ... ¶ |
| | −0.2271 * estrogen ...¶ |
| | +0.3865 * e.SOX4 ... ¶ |
| | −3.3;¶ |

```
        ¶
    case ‘P7b’ ¶
        % motives¶
        prolif = 0.6 * e.RACGAP1 + 0.4 * e.UBE2C;¶
        immune = 0.5 * e.IGKC + 0.5 * e.CXCL13;¶
  ¶
        % final risk¶
```

| | |
|---|---|
| risk = | +0.4127 * prolif ...¶ |
| | −0.1921 * immune ...¶ |
| | −0.1159 * e.PGR ... ¶ |
| | +0.0876 * e.MMP1 ...¶ |
| | −1.95;¶ |

```
        ¶
    case ‘P7c’ ¶
        % motives¶
        prolif = 0.6 * e.RACGAP1 + 0.4 * e.UBE2C;¶
        immune = 0.5 * e.IGKC + 0.5 * e.CXCL13;¶
  ¶
        % final risk¶
```

| | |
|---|---|
| risk = | +0.4084 * prolif ... ¶ |
| | −0.1891 * immune ... ¶ |
| | −0.1017 * e.PGR ... ¶ |
| | +0.0775 * e.MMP1 ... ¶ |
| | +0.0693 * e.VEGF ... ¶ |
| | −0.0668 * e.CHPT1 ...¶ |
| | −1.95;¶ |

```
  ¶
    otherwise¶
        error(‘unknown algorithm’);¶
  end¶
  end¶
  ¶
  ¶
  ¶
  function y = logit(x)¶
y = 1./(1 + exp(−x)); ¶
end¶
  ¶
  ¶
  ¶
% end of file¶
```

The following is a Matlab script containing a further example of an algorithm used in the invention (Matlab R2007b, Version 7.5.0.342, © by The MathWorks Inc.). User-defined comments are contained in lines preceded by the “%” symbol. These comments are overread by the program and are for the purpose of informing the user/reader of the script only. Command lines are not preceded by the “%” symbol:

function risk = predict(e)¶
% input “e”: gene expression values of patients. Variable “e” is of type¶
% struct, each field is a numeric vector of expression values of the¶
% patients. The field name corresponds to the gene name. Expression¶
% values are pre-processed delta-CT values.¶
% output risk: vector of risk scores for the patients. The higher the
score¶
% the higher the estimated probability for a metastasis or desease-¶
% related death to occur within 5 or 10 years after surgery. Negative¶
% risk scores are called “low risk”, positive risk score are called
“high¶
% risk”.¶
¶
expr = [20 * ones(size(e.CXCL13)), ... % Housekeeper HKM¶
e.CXCL13, e.ESR1, e.IGKC, e.MLPH, e.MMP1, e.PGR, e.TOP2A,
e.UBE2C];¶
¶

| m = | [ ...¶ |
|---|---|
| | 20, 20; ...¶ |
| | 11.817, 11.1456; ...¶ |
| | 17.1194, 16.7523; ...¶ |
| | 11.6005, 10.046; ...¶ |
| | 16.6452, 16.1309; ...¶ |
| | 9.54657, 10.9477; ...¶ |
| | 13.181, 12.0208; ...¶ |
| | 12.9811, 13.811; ...¶ |
| | 14.1037, 14.708];¶ |

risk = corr(expr′, m(:, 2)) − corr(expr′, m(:, 1)) + 0.08;¶
end¶
¶
¶
¶
% end of file¶

The following is a Matlab script file which contains an implementation of the prognosis algorithm including the whole data pre-processing of raw CT values (Matlab R2007b, Version 7.5.0.342, © by The MathWorks Inc. The preprocessed delta CT values may be directly used in the above described algorithms:

It is known that the expression of various genes correlate strongly. Therefore single or multiple genes used in the method of the invention may be replaced by other correlating genes. The following tables give examples of correlating genes for each gene used in the above described methods, which may be used to replace single or multiple gene. The top line in each of the following tables contains the primary gene of interest, in the lines below are listed correlated genes, which may be used to replace the primary gene of interest in the above described methods.

| RPL37A | GAPDH | ACTG1 | CALM2 |
|---|---|---|---|
| RPL38 | ENO1 | EEF1A1 | RPL41 |
| — | PGK1 | RPS3A | EEF1A1 |
| EEF1D | HSPA8 | RPL37A | RPS10 |
| RPLP2 | ACTB | RPLP0 | RPS27 |
| RPS10 | HSPCB | RPS23 | RPL37A |
| XTP2 | STIP1 | RPS28 | RPL39 |
| FKSG49 | ZNF207 | ACTB | ACTB |
| RPS11 | PSMC3 | RPL23A | RPLP0 |
| ENO1 | MSH6 | RPL7 | RPS3A |
| INHBC | TKT | RPL39 | RPS2 /// LOC91561 /// |
| | | | LOC148430 /// LOC286444 /// |
| | | | LOC400963 /// LOC440589 |
| RPL14 | PSAP | LOC389223 /// | PPIA |
| | | LOC440595 | |
| ATP6V0E | RAN | TPT1 | RPL3 |
| OPHN1 | GDI2 | RPL41 | RPS18 |
| JTV1 | WDR1 | HUWE1 | RPS2 |
| E2F4 | ILF2 | RPL3 | RPS12 |
| ATP6V1D | ABCF2 | RPL13A | ACTG1 |
| EIF5B | USP4 | RPS4X | RPL23A |
| CTAGE1 | HNRPC | RPS18 | RPL13A |
| NUCKS | MAPRE1 | RPS10 | MUC8 |
| TRA1 | C7orf28A | RPS17 | RPLP1 |
| | /// | | |
| | C7orf28B | | |

| OAZ1 | PPIA | CLEC2B | CXCL13 |
|---|---|---|---|
| C19orf10 | K-ALPHA-1 | LY96 | TRBV19 /// TRBC1 |
| MED12 | ACTG1 | WASPIP | CD2 |
| AP2S1 | ACTB | DCN | CD52 |
| LOC222070 | RPS2 | SERPING1 | TNFRSF7 |
| CTGLF1 /// LOC399753 /// | RPL23A | C1S | CD3D |
| FLJ00312 /// CTGLF2 | | | |
| RAB1A | RPL39 | SERPINF1 | LCK |
| ARPC4 | RPL37A | PTGER4 | MS4A1 |
| ARFRP1 | GAPDH | CUGBP2 | CD48 |
| NUP214 | CHCHD2 | KCTD12 | SELL |
| POLR2E | RPS10 | EVI2A | IGHM |
| C2orf25 | RPL13A | HLA-E | POU2AF1 |
| UBE2D3 | TUBA6 | AXL | TRBV21-1 /// TRBV19 /// |
| | | | TRBV5-4 /// TRBV3-1 /// TRBC1 |
| ATP6V0E | RPLP0 | C1R | TRAC |
| XKR8 | RPL30 | CFH /// | CCL5 |
| | | CFHL1 | |
| LOC401210 | GNAS | PTPRC | NKG7 |
| PARVA | DDX3X | SART2 | CD3Z |
| — | H3F3A | DAB2 | IL2RG |
| PPP2R5D | H3F3A /// | CLIC2 | CD38 |
| | LOC440926 | | |
| ZNF337 | RPS18 | PRRX1 | CD19 |
| TMEM4 | RPL41 | IFI16 | BANK1 |

| DHRS2 | ERBB2 | H2AFZ | IGHG1 |
|---|---|---|---|
| CXorf40A /// | PERLD1 | MAD2L1 | APOL5 |
| CXorf40B | | | |
| DEGS1 | STARD3 | CDC2 | RARB |
| ALDH3B2 | GRB7 | CCNB1 | CLDN18 |
| SLC9A3R1 | CRK7 | CCNB2 | HBZ |
| INPP4B | PPARBP | CENPA | MUC3A |
| TP53AP1 | CASC3 | KPNA2 | — |
| EMP2 | PSMD3 | ASPM | APOC4 |
| CACNG4 | PNMT | CDCA8 | ACRV1 |
| SULT2B1 | THRAP4 | KIF11 | FSHR |
| DEK | WIRE | CCNA2 | SPTA1 |
| DHCR24 | LOC339287 | ECT2 | EPC1 |
| RBM34 | PCGF2 | PTTG1 | MYO15A |
| SLC38A1 | GSDML | BUB1 | GP1BB |
| AGPS | PIP5K2B | MELK | OR2B2 |
| CXorf40B | RPL19 | RRM2 | ENO1 |
| MSX2 | PPP1R10 | TPX2 | TCF21 |
| STC2 | LASP1 | DLG7 | GYPB |
| C14orf10 | SPDEF | MLF1IP | WNT6 |
| CREG1 | PSMB3 | STK6 | ASH1L |
| JMJD2B | GPC1 | BM039 | RPL37A |

| IGKC | KCTD3 | MLPH | MMP1 |
|---|---|---|---|
| — | TSNAX | FOXA1 | SLC16A3 |
| IGL@ /// IGLC1 /// IGLC2 /// IGLV3-25 /// | C1orf22 | SPDEF | KIAA1199 |
| IGLV2-14 | | | |
| IGLC2 | GATA3 | GATA3 | CTSB |
| IGKC /// IGKV1-5 | LGALS8 | AGR2 | SLAMF8 |
| LOC391427 | FOXA1 | CA12 | CORO1C |
| IGL@ /// IGLC1 /// IGLC2 /// IGLV3-25 /// | MCP | ESR1 | PLAU |
| IGLV2-14 /// IGLJ3 | | | |
| IGKV1D-13 | SSA2 | KIAA0882 | AQP9 |
| IGLV2-14 | IL6ST | SCNN1A | PDGFD |
| LOC339562 | GGPS1 | XBP1 | RGS5 |
| IGKV1-5 | CCNG2 | RHOB | PLAUR |
| IGLJ3 | DHX29 | FBP1 | CHST11 |
| LOC91353 | ZNF281 | GALNT7 | SOD2 |
| IGHA1 /// IGHD /// IGHG1 /// IGHM /// | FLJ20273 | MYO5C | TREM1 |
| LOC390714 | | | |
| LOC91316 | KIAA0882 | TFF3 | HN1 |
| IGHM | C1orf25 | CELSR1 | MRPS14 |
| IGHA1 /// IGHG1 /// IGHG3 /// | ABAT | LOC400451 | ACTR3 |
| LOC390714 | | | |
| IGH@ /// IGHG1 /// IGHG2 /// IGHG3 /// | HNRPH2 | SLC44A4 | RIPK2 |
| IGHM | | | |
| IGH@ /// IGHA1 /// IGHA2 /// IGHD /// | MRPS14 | MUC1 | ECHDC2 |
| IGHG1 /// IGHG2 /// IGHG3 /// IGHM /// | | | |
| MGC27165 /// LOC390714 | | | |
| IGJ | KIAA0040 | KIAA1324 | GBP1 |
| POU2AF1 | ERBB2IP | KRT18 | RRM2 |

| PGR | SOX4 | TOP2A | UBE2C | ESR1 | VEGF |
|---|---|---|---|---|---|
| IL6ST | MARCKSL1 | TPX2 | BIRC5 | CA12 | ESM1 |
| MAPT | DSC2 | KIF11 | TPX2 | GATA3 | FLT1 |
| GREB1 | HOMER3 | CDC2 | STK6 | KIAA0882 | COL4A1 |
| ABAT | TMSB10 | ASPM | CCNB2 | MLPH | LSP1 |
| SCUBE2 | TCF3 | NUSAP1 | KIF2C | IL6ST | EPOR |
| NAT1 | ZNF124 | KIF4A | CDC20 | FOXA1 | COL4A2 |
| LRIG1 | PCAF | KIF20A | PTTG1 | SLC39A6 | PTGDS |
| SLC39A6 | PTMA | CCNB2 | PRC1 | C6orf97 | ENTPD1 |
| RBBP8 | IGSF3 | BIRC5 | NUSAP1 | C6orf211 | BNIP3 |
| SIAH2 | ENC1 | C10orf3 | C10orf3 | MYB | TPST1 |
| ARL3 | MTF2 | UBE2C | CENPA | ANXA9 | GLIPR1 |
| C9orf116 | E2F3 | SPAG5 | KIF4A | FBP1 | ZNFN1A1 |
| CA12 | TGIF2 | STK6 | RACGAP1 | SCNN1A | PCDH7 |
| MGC35048 | DBN1 | CCNB1 | ZWINT | MAPT | RGS13 |
| STC2 | DSP | NEK2 | PSF1 | NAT1 | GAS7 |
| MEIS4 | KLHL24 | RACGAP1 | BUB1B | CELSR1 | LOC56901 |
| ADCY1 | PPP1R14B | KIF2C | DLG7 | PH-4 | TLR4 |
| C6orf97 | OPN3 | PTTG1 | FOXM1 | EVL | SYNCRIP |
| ESR1 | HSPA5BP1 | MKI67 | LOC146909 | XBP1 | EVI2A |
| NME5 | CREBL2 | MAD2L1 | ESPL1 | AGR2 | FNBP3 |

| EIF4B | NAT1 | CA12 | RACGAP1 | DCN |
|---|---|---|---|---|
| IMPDH2 | PSD3 | ESR1 | UBE2C | FBLN1 |
| NACA | EVL | GATA3 | NUSAP1 | GLT8D2 |
| RPL13A | ESR1 | SCNN1A | STK6 | SERPINF1 |
| RPL29 | KIAA0882 | MLPH | PSF1 | PDGFRL |
| RPL14 /// RPL14L | MAPT | FOXA1 | CCNB2 | CXCL12 |
| ATP5G2 | C9orf116 | IL6ST | ZWINT | CRISPLD2 |
| GLTSCR2 | ASAH1 | KIAA0882 | LOC146909 | CTSK |
| RPL3 | PCM1 | ANXA9 | BIRC5 | FSTL1 |
| TINP1 | SCUBE2 | BHLHB2 | PRC1 | SFRP4 |
| RPL15 | IL6ST | XBP1 | C10orf3 | FBN1 |
| QARS | ABAT | AGR2 | TPX2 | SPARC |
| LETMD1 | MLPH | MAPT | KIF11 | CDH11 |
| PFDN5 | VAV3 | JMJD2B | DLG7 | FAP |
| EEF2 | C14orf45 | RHOB | TOP2A | SPON1 |
| RPL6 | FOXA1 | CELSR1 | MELK | C1S |
| RPL29 /// LOC283412 | GATA3 | SPDEF | CENPA | PRRX1 |
| /// LOC284064 /// | | | | |
| LOC389655 /// | | | | |
| LOC391738 /// | | | | |
| LOC401911 | | | | |
| RPL18 | KIF13B | VGLL1 | NEK2 | RECK |
| EEF1B2 | CA12 | KRT18 | KIF2C | CSPG2 |
| RPL10A | MUC1 | C1orf34 | CCNB1 | LUM |
| RPS9 | C4A /// C4B | WWP1 | KIF20A | ANGPTL2 |

| CTSB | IGFBP3 | KRT17 | GABRP | FBXO28 | KIAA0101 |
|---|---|---|---|---|---|
| IFI30 | VIM | KRT14 | SOX10 | PARP1 | NUSAP1 |
| FCER1G | EFEMP2 | KRT5 | SFRP1 | EPRS | RRM2 |
| NPL | C1R | KRT6B | ROPN1B | IARS2 | CCNB2 |
| LAPTM5 | GAS1 | TRIM29 | KRT5 | CGI-115 | ZWINT |
| FCGR1A | PLS3 | MIA | MIA | C1orf37 | PRC1 |
| CD163 | SNAI2 | DST | MMP7 | TFB2M | DTL |
| TYROBP | SERPING1 | ACTG2 | KRT17 | WDR26 | TPX2 |
| NCF2 | CFH /// | SFRP1 | DMN | RBM34 | KIF11 |
| | CFHL1 | | | | |
| FCGR2A | ID3 | MYLK | KRT6B | FH | C10orf3 |
| ITGB2 | CFH | GABRP | BBOX1 | POGK | CDC2 |
| LILRB1 | ENPP2 | S100A2 | VGLL1 | NVL | NEK2 |
| OLR1 | FSTL1 | SOX10 | BCL11A | TIMM17A | ASF1B |
| C1QB | NXN | ANXA8 | TRIM29 | ADSS | BIRC5 |
| ATP6V1B2 | C10orf10 | DMN | CRYAB | CACYBP | KIF4A |
| FCGR1A /// | FBLN1 | BBOX1 | SERPINB5 | CNIH4 | BUB1B |
| LOC440607 | | | | | |
| SLC16A3 | NNMT | SERPINB5 | SOSTDC1 | GGPS1 | KIF20A |
| MSR1 | C1S | KCNMB1 | NFIB | DEGS1 | UBE2C |
| PLAUR | IFI16 | DSG3 | ELF5 | FAM20B | MLF1IP |
| CHST11 | NRN1 | DSC3 | KRT14 | MRPS14 | TOP2A |
| FTL | PDGFRA | KLK5 | ANXA8 | TBCE | C22orf18 |

| CHPT1 | PCNA | CCND1 | NEK2 | NR2F2 | PDLIM5 |
|---|---|---|---|---|---|
| SGK3 | PSF1 | CA12 | ASPM | SORBS1 | CRSP8 |
| STC2 | MAD2L1 | TLE3 | DTL | IGF1 | RSL1D1 |
| PKP2 | RAD51AP1 | SLC39A6 | CENPF | AOC3 | FZD1 |
| CCNG2 | CDC2 | ESR1 | NUSAP1 | LHFP | PUM1 |
| SP110 | MLF1IP | PPFIA1 | TPX2 | ABCA8 | FAM63B |
| ACADM | H2AFZ | MAGED2 | CCNB2 | GNG11 | DCTD |
| GCHFR | TPX2 | FN5 | C10orf3 | ADH1B | APP |
| ABCD3 | CCNE2 | WWP1 | KIF20A | FHL1 | — |
| IL6ST | RACGAP1 | C10orf116 | UBE2C | MEOX2 | DXS9879E |
| TSPAN6 | MCM2 | JMJD2B | TOP2A | C5orf4 | HFE |
| WDR26 | KIF11 | FBP1 | CDC2 | PPAP2A | GLRB |
| CELSR3 | CCNB1 | UBE2E3 | BIRC5 | COL14A1 | MRPS18A |
| TFCP2L1 | DLG7 | AGR2 | KIAA0101 | CAV1 | BMPR1B |
| STXBP3 | CDCA8 | FOXA1 | FOXM1 | LPL | SAV1 |
| NAP1L1 | NUSAP1 | FADD | RRM2 | P2RY5 | TROAP |
| MYBPC1 | STK6 | TEGT | RACGAP1 | FABP4 | RPS2 /// LOC91561 /// |
| | | | | | LOC148430 /// LOC286444 /// |
| | | | | | LOC400963 /// LOC440589 |
| DSG2 | CCNB2 | COPZ1 | KIF11 | CHRDL1 | TOMM40 |
| OSBPL1A | RNASEH2A | MRPS30 | PRC1 | ELK3 | ITGAV |
| SEC14L2 | MELK | KRT18 | CCNB1 | C10orf56 | ESPL1 |
| ARL1 | ZWINT | FKBP4 | ZWINT | ITM2B | MAP4K5 |

| PRC1 | FHL1 |
|---|---|
| NUSAP1 | CHRDL1 |
| CCNB2 | FABP4 |
| BIRC5 | AOC3 |
| UBE2C | ADH1B |
| FLJ10719 | G0S2 |
| TPX2 | CAV1 |
| BUB1B | ITIH5 |
| FOXM1 | ADIPOQ |
| C10orf3 | LHFP |
| KIF11 | ABCA8 |
| KIF2C | GPX3 |
| KIF4A | PLIN |
| LOC146909 | DPT |
| ZWINT | TNS1 |
| CENPA | LPL |
| PTTG1 | GPD1 |
| DLG7 | SRPX |
| STK6 | RBP4 |
| KIAA0101 | CIDEC |
| RACGAP1 | TGFBR2 |

In summary, the present invention is predicated on a method of identification of a panel of genes informative for the outcome of disease which can be combined into an algorithm for a prognostic or predictive test.

1. Method for predicting an outcome of cancer in a patient suffering from, said patient having been previously diagnosed as node positive, said method comprising:
(a) determining in a biological sample from said patient an expression level of a plurality of genes selected from the group consisting of ACTG1, CAl2, CALM2, CCND1, CHPT1, CLEC2B, CTSB, CXCL13, DCN, DHRS2, EIF4B, ERBB2, ESR1, FBXO28, GABRP, GAPDH, H2AFZ, IGFBP3, IGHG1, IGKC, KCTD3, KIAA0101, KRT17, MLPH, MMP1, NAT1, NEK2, NR2F2, OAZ1, PCNA, PDLIM5, PGR, PPIA, PRC1, RACGAP1, RPL37A, SOX4, TOP2A, UBE2C and VEGF; ABCB1, ABCG2, ADAM15, AKR1C1, AKR1C3, AKT1, BANF1, BCL2, BIRC5, BRMS1, CASP10, CCNE2, CENPJ, CHPT1, EGFR, CTTN, ERBB3, ERBB4, FBLN1, FIP1L1, FLT1, FLT4, FNTA, GATA3, GSTP1, Herstatin, IGF1R, IGHM, KDR, KIT, CKRT5, SLC39A6, MAPK3, MAPT, MKI67, MMP1, MTA1, FRAP1, MUC1, MYC, NCOA3, NFIB, OLFM1, TP53, PCNA, PI3K, PPERLD1, RAB31, RAD54B, RAFT, SCUBE2, STAU, TINF2, TMSL8, VGLL1, TRA@, TUBA1, TUBB, TUBB2A;
(b) based on the expression level of the plurality of genes determined in step (a) determining a risk score for each gene; and
(c) mathematically combining said risk scores to yield a combined score, wherein said combined score is indicative of outcome of said patient.

2. Method of claim 1, wherein said combined score is indicative of benefit from taxane therapy of said patient.

3. Method of claim 1, wherein one, two or more thresholds are determined for said combined score and discriminated into high and low risk, high, intermediate and low risk, or more risk groups by applying the threshold on the combined score.

4. Method of claim 1 additionally comprising the step of mathematically combining said combined risk score obtained in step (c) with an expression level of at least one of the genes determined in step (a) whereas the result of the combination is indicative of benefit from taxane therapy of said patient.

5. Method claim 1, wherein an expression level of a plurality of genes selected from the group consisting of CALM2, CHPT1, CXCL13, ESR1, IGKC, MLPH, MMP1, PGR, PPIA, RACGAP1, RPL37A, TOP2A and UBE2C is determined.

6. Method of claim 1 wherein said prediction of outcome is the determination of the risk of recurrence of cancer in said patient within 5 to 10 years or the risk of developing distant metastasis in a similar time horizon, or the prediction of death or of death after recurrence within 5 to 10 years after surgical removal of the tumor.

7. Method of claim 1, wherein said prediction of outcome is a classification of said patient into one of three distinct classes, said classes corresponding to a “high risk” class, an “intermediate risk” class and a “low risk” class.

8. Method of claim 1, wherein said cancer is breast cancer.

9. Method of claim 1, wherein said determination of expression levels is in a formalin-fixed paraffin embedded sample or in a fresh-frozen sample.

10. Method of claim 1, comprising the additional steps of:
(d) classifying said sample into one of at least two clinical categories according to clinical data obtained from said patient and/or from said sample, wherein each category is assigned to at least one of said genes of step (a); and
(e) determining for each clinical category a risk score;
wherein said combined score is obtained by mathematically combining said risk scores of each patient.

11. Method of claim 10, wherein said clinical data comprises at least one gene expression level.

12. Method of claim 11, wherein said gene expression level is a gene expression level of at least one of the genes of step (a).

13. Method of claim 1, wherein step (d) comprises applying a decision tree.

14. Method of claim 1, wherein the patient has previously received treatment by surgery and cytotoxic chemotherapy.

15. Method of claim 14, wherein the cytotoxic chemotherapy comprises administering a taxane compound or taxane derived compound.

16. Method of claim 2, wherein one, two or more thresholds are determined for said combined score and discriminated into high and low risk, high, intermediate and low risk, or more risk groups by applying the threshold on the combined score.

17. Method of claim 2, additionally comprising the step of mathematically combining said combined risk score obtained in step (c) with an expression level of at least one of the genes determined in step (a) whereas the result of the combination is indicative of benefit from taxane therapy of said patient.

18. Method claim 2, wherein an expression level of a plurality of genes selected from the group consisting of CALM2, CHPT1, CXCL13, ESR1, IGKC, MLPH, MMP1, PGR, PPIA, RACGAP1, RPL37A, TOP2A and UBE2C is determined.

19. Method of claim 2, wherein said prediction of outcome is the determination of the risk of recurrence of cancer in said patient within 5 to 10 years or the risk of developing distant metastasis in a similar time horizon, or the prediction of death or of death after recurrence within 5 to 10 years after surgical removal of the tumor.

20. Method of claim 2, wherein said prediction of outcome is a classification of said patient into one of three distinct classes, said classes corresponding to a “high risk” class, an “intermediate risk” class and a “low risk” class.
